(19) United States
(12) Patent Application Publication
(10) Pub. No.: US 2016/0210315 A1
(43) Pub. Date: Jul. 21, 2016

(54) Systems and Methods for Data Mart Assembly

(71) Applicant: The Procter & Gamble Company, Cincinnati, OH (US)

(72) Inventor: Jan Wenda, Warsaw (PL)

(21) Appl. No.: 14/995,411

(22) Filed: Jan. 14, 2016

Related U.S. Application Data
(60) Provisional application No. 62/103,677, filed on Jan. 15, 2015.

(51) Int. Cl. G06F 17/30; G06Q 40/00

(52) U.S. Cl. CPC G06F 17/30289; G06Q 40/12

(57) ABSTRACT

Included are embodiments for data mart assembly. Some embodiments of the method include receiving a plurality of slices of structured data, providing an option to graphically assemble a data mart from at least a portion of the plurality of slices of structured data for a first project, and providing an option to access a previously created data mart from a data mart repository for inclusion in the first project. Some embodiments include associating the data mart with a first user, such that the first user is provided with an option to utilize the data mart for a second project, where the first project is different than the second project.

### FIELD OF THE INVENTION

The present application relates generally systems and methods for data mart assembly and specifically to providing a user interface for assembling data marts that may be utilized for a plurality of different projects.

### BACKGROUND OF THE INVENTION

Data marts may be utilized for providing information to users. Specifically, data marts may include a slice of a data warehouse that is utilized for a predetermined business line and/or team. While data marts have proven to be useful in this capacity, oftentimes, data marts are difficult and time consuming to create. Additionally, many current solutions do not provide the ability to easily manipulate or otherwise alter a data mart. As a consequence, extraordinary cost and effort is currently being expended to create and maintain data marts.

### SUMMARY OF THE INVENTION

Included are embodiments of a method for data mart assembly. Some embodiments of the method include receiving a plurality of slices of structured data, providing an option to graphically assemble a data mart from at least a portion of the plurality of slices of structured data for a first project, and providing an option to access a previously created data mart from a data mart repository for inclusion in the first project. Some embodiments include associating the data mart with a first user, such that the first user is provided with an option to utilize the data mart for a second project, where the first project is different than the second project.

Also included are embodiments of a system. Some embodiments of the system may include a memory component that stores logic that, when executed by a processor, causes the system to receive a plurality of slices of structured data, provide an option to graphically assemble a data mart from at least a portion of the plurality of slices of structured data for a first project, and associate the data mart with a first user, such that the first user is provided with an option to utilize the data mart for a second project, where the first project is different than the second project. In some embodiments, the logic may cause the system to associate the data mart with a data mart repository, such that a second user is provided with an option to utilize the data mart for a third project, where the third project is different than the first project and the second project.

Also included are embodiments of a non-transitory computer-readable medium. Some embodiments of the non-transitory computer-readable medium include logic that causes a computing device to receive a plurality of slices of structured data, provide an option to graphically assemble a data mart from at least a portion of the plurality of slices of structured data for a first project, and in response to receiving a user command to graphically assemble the data mart, create the data mart and assemble the data mart with a user-selected component. In some embodiments, the logic causes the computing device to provide an option to access a previously created data mart from a data mart repository for inclusion in the first project and associate the data mart with a first user, such that the first user is provided with an option to utilize the data mart for a second project, wherein the first project is different than the second project.

### BRIEF DESCRIPTION OF THE DRAWINGS

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate various embodiments described herein, and together with the description serve to explain the principles and operations of the claimed subject matter.

FIG. 1 depicts a computing environment for assembling data marts, according to embodiments disclosed herein;

FIG. 2 depicts a remote computing device that may be utilized for assembling data marts, according to embodiments disclosed herein;

FIG. 3 depicts a user interface for viewing a data mart that is associated with a user, according to embodiments disclosed herein;

FIG. 4 depicts a user interface for viewing data marts that a user may access, according to embodiments disclosed herein;

FIG. 5 depicts a user interface for viewing data mart processes, according to embodiments disclosed herein;

FIG. 6 depicts a user interface for viewing process details for a data mart process, according to embodiments disclosed herein;

FIG. 7 depicts a user interface for providing a process data overview, according to embodiments disclosed herein;

FIG. 8 depicts a user interface for providing cost data associated with a data mart, according to embodiments disclosed herein;

FIG. 9 depicts a user interface for providing a data mart's cost and maintaining budget allocation, according to embodiments disclosed herein;

FIG. 10 depicts a user interface for providing data mart costs, according to embodiments disclosed herein;

FIG. 11 depicts a user interface for adding, modifying, and/or deleting a data source, according to embodiments disclosed herein; and

FIG. 12 depicts a flowchart for assembling data marts, according to embodiments disclosed herein.

### DETAILED DESCRIPTION OF THE INVENTION

Embodiments disclosed herein include systems and methods for easily assembling data marts for data management projects. Specifically, many current data marts are cumbersome, costly and time consuming to create, and costly and time consuming to manage. Accordingly, embodiments provided herein may be configured to create data marts via a drag and drop functionality. Some embodiments may be configured to create a parallel workflow for creating data marts, which significantly reduces time for creation, implementation, and allows reusing one or more components of a data mart for future updates, data marts, and projects.

Additionally, because the data marts may be created by a plurality of different users in a significantly shorter timeframe, the data marts may be created with very few (or no) interdependencies. Additionally, embodiments described herein may be centrally governed to ensure that data marts adhere to predetermined quality and formatting criteria. As an example, embodiments may be configured to prevent data marts from reaching a predetermined size and/or monitor a size of a data mart such that if a data mart exceeds a predetermined size, these embodiments may prevent publication and/or utilization of that data mart. Embodiments may also provide the ability to determined and provide clear ownership of data marts and the respective budget owners. Direct charges to a service's cost center may also be easily determined and provided.

Additionally, some embodiments may be configured to build small data marts for individual needs, with no interdependencies making them fast and easy to build and change. Similarly, some embodiments may be configured to utilize typical data warehousing components (such as joins, aggregators, etc.) but also encapsulate complex business logic (such as encapsulating multi-step processing business logic) into simple to use, configurable and reusable component. Similarly, some embodiments may be configured for assembly of the data marts in a production environment without the need to follow traditional application development life cycle with gated phases (requirements, design, development, technical tests, business acceptance tests, production). Thus, these embodiments may be configured such that the data mart is first assembled after commencement of a life cycle of a project. This is possible thanks to assembly form building blocks with no-coding and self-documenting data mart documentation is generated automatically for support teams.

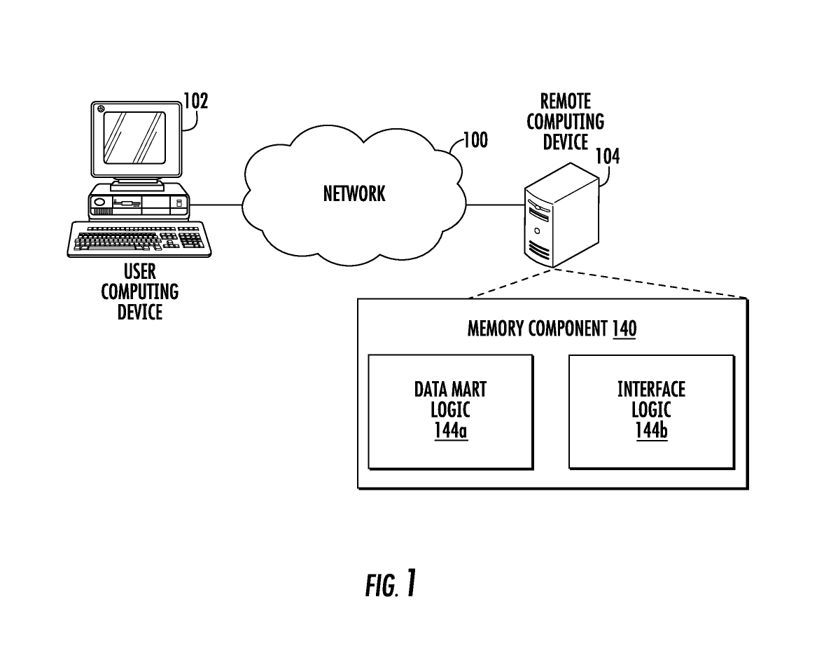

Referring now to the drawings, FIG. 1 depicts a computing environment for assembling data marts, according to embodiments disclosed herein. As illustrated, the computing environment may include a network 100, which may include a wide area network (wired or wireless), such as the internet, a cellular network, or other communications network for communicating devices across a wide area. Additionally, the network 100 may include a wired or wireless local area network for communicating data, as described herein.

Coupled to the network 100 is a computing device, such as user computing device 102. The user computing device 102 may be configured for discrete computer programmers to create and/or edit data marts and submit those data marts for verification and/or implementation. As discussed in more detail below, the user computing device 102 may additionally interface with the remote computing device 104 to receive criteria for the data mart, as well as view an assessment of at least one feature of the data mart will include.

The remote computing device 104 may include a memory component 140 that stores data marts logic 144a and interface logic 144b. The data marts logic 144a may include one or more components, such as for facilitating creation and/or editing of a data mart. The interface logic 144b may be configured to cause the remote computing device 104 to provide the user interfaces and/or drag and drop functionality in creating the data marts.

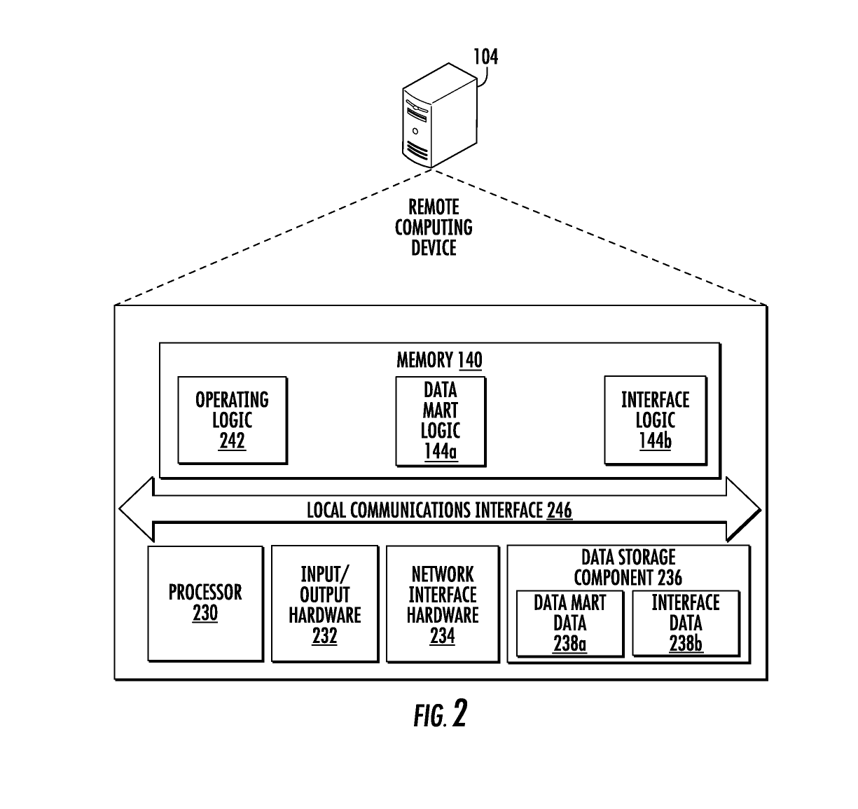

FIG. 2 depicts a remote computing device 104 that may be utilized for assembling data marts, according to embodiments disclosed herein. As illustrated, the remote computing device 104 includes a processor 230, input/output hardware 232, a network interface hardware 234, a data storage component 236 (which stores data mart data 238a and/or interface data 238b), and a memory component 140. The memory component 140 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, these non-transitory computer-readable mediums may reside within the remote computing device 104 and/or external to the remote computing device 104.

The memory component 140 may store operating logic 242, the data marts logic 144a, and the interface logic 144b. Each of these logic components may include a plurality of different pieces of logic, each of which may be embodied as a computer program, firmware, and/or hardware, as an example. A local interface 246 is also included in FIG. 2 and may be implemented as a bus or other communication interface to facilitate communication among the components of the remote computing device 104.

The processor 230 may include any processing component operable to receive and execute instructions (such as from a data storage component 236 and/or the memory component 134). As described above, the input/output hardware 232 may include and/or be configured to interface with the components of FIG. 2.

The network interface hardware 234 may include and/or be configured for communicating with any wired or wireless networking hardware, including an antenna, a modem, a LAN port, wireless fidelity (Wi-Fi) card, WiMax card, mobile communications hardware, and/or other hardware for communicating with other networks and/or devices. From this connection, communication may be facilitated between the remote computing device 104 and other computing devices.

The operating logic 242 may include an operating system and/or other software for managing components of the remote computing device 104. Similarly, as discussed above, the data marts logic 144a may reside in the memory component 140 and may be configured to cause the processor 230 to provide a framework for creating and/or editing one or more data marts. The interface logic 144b may be configured to cause the memory component 140 to cause the processor 230 to provide user interfaces and/or drag and drop functionality in creating and editing those data marts.

It should be understood that while the components in FIG. 2 are illustrated as residing within the remote computing device 104, this is merely an example. In some embodiments, one or more of the components may reside external to the remote computing device 104 or within other devices, such as those depicted in FIG. 1. It should also be understood that, while the remote computing device 104 is illustrated as a single device, this is also merely an example. In some embodiments, the data marts logic 144a and the interface logic 144b may reside on different computing devices. As an example, one or more of the functionalities and/or components described herein may be provided by the user computing device 102 and/or the remote computing device 104.

Additionally, while the remote computing device 104 is illustrated with the data marts logic 144a and the interface logic 144b as separate logical components, this is also an example. In some embodiments, a single piece of logic may provide the described functionality.

It should also be understood that while the data marts logic 144a and the interface logic 144b are described herein as the logical components, this is also an example. Some embodiments may utilize a data sources repository, a data marts repository, a cost management module, a logs and statistics module, an execution engine. Additionally, some embodiments include a join component, an aggregation component, a measures calculator component, a promotion component, an email component, a share component, a past methods component, a previous period component, a partitions processing component, an incremental promotion component, a copy forward component, an other calculation component, and/or a linear regression component. Other components may also be included, depending on the embodiment.

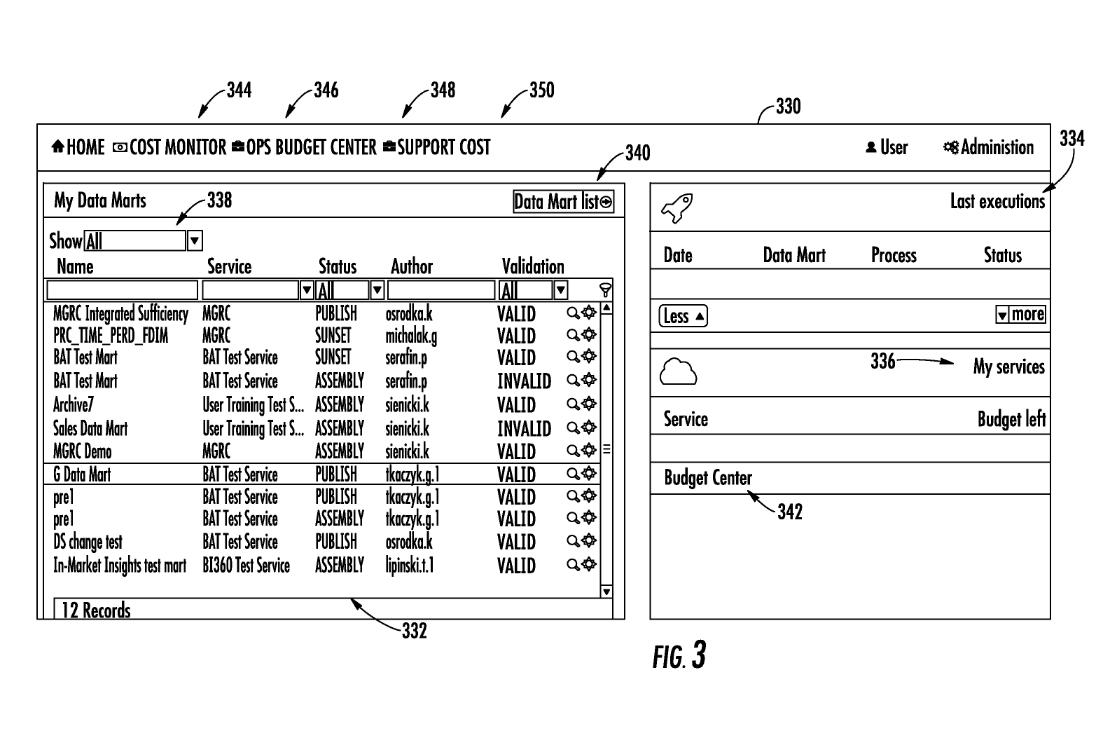

FIG. 3 depicts a user interface 330 for viewing a data mart that is associated with a user, according to embodiments disclosed herein. As illustrated, the user interface 330 may include a data mart repository of personal data marts section 332, a last executions section 334, and a personal services section 336. The personal data marts section 332 may include a plurality of data marts that a particular user has created and/or has access. Specifically, a name of the data mart, a service, a status, and author, and a validation may be provided for one or more of the data marts. The personal data marts section 332 may be configured to provide a single interface for providing a plurality of data marts that the user may utilize. The user may utilize the personal data marts section 332 for editing an existing data mart or creating a new data mart, based on the existing data mart. A view option 338 may provide views for all data marts, data marts created by a particular user, filtered by date, and/or filtered by other criteria. A data marts list option 340 may also be provided for providing differing views of the data marts provided in the personal data marts section 332.

Similarly, the last executions section 334 may include a listing of a data mart's processes that have last been executed. Some embodiments may provide a listing of those data marts' processes executed by a particular user and/or which of the data marts created by a particular user have been executed. Regardless, a date, name, process, and status may be provided for at least one of the data marts provided in the last executions section 334. The personal services section 336 may be configured to provide the services that are associated with the particular user. Specifically, a service may be provided and may include a predetermined budget. Accordingly, the remaining budget may be provided in the personal services section 336. A budget center option 342 may also be provided for viewing budgets of a plurality of different services.

Also provided are a home option 344, a cost monitor option 346, a budget center option 348, and a support cost option 350. The home option 344 may take the user to the user interface 330 from FIG. 3. The cost monitor option 346 may provide information related to costs associated with a project and/or user. The budget center option 348 may provide data similar to that provided in response to the budget center option 342. The support cost option 350 may provide support on cost data associated with a process, data mart, and/or other data.

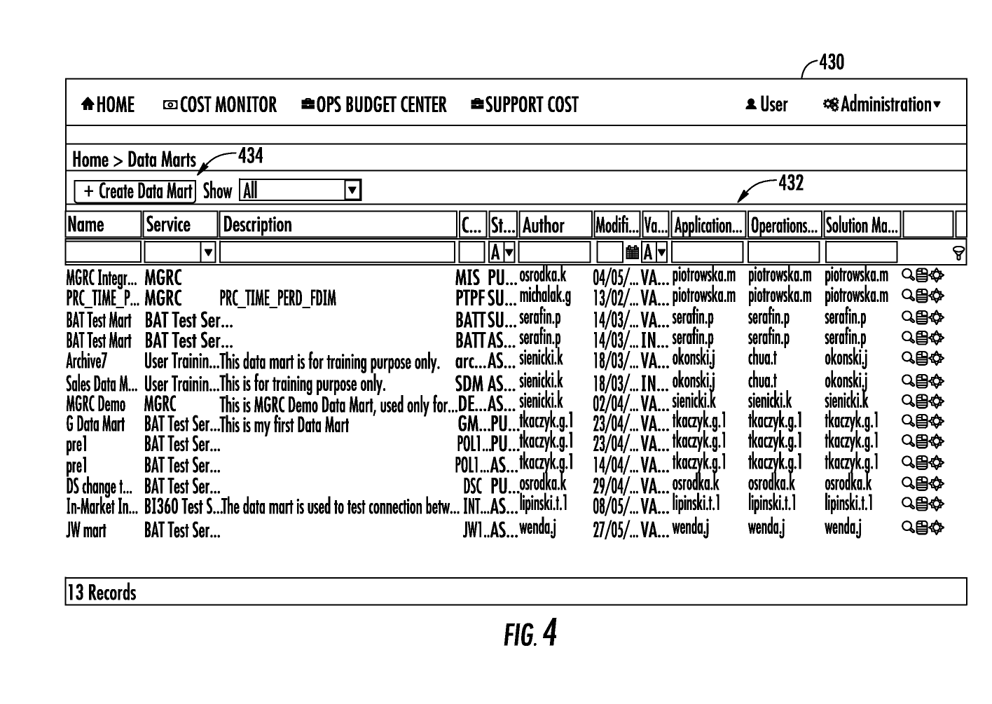

FIG. 4 depicts a user interface 430 for viewing data marts that a user may access, according to embodiments disclosed herein. In response to selection of the data marts list option 340 from FIG. 3, the user interface 430 may be provided. The user interface 403 may include a data marts section 432, which provides a listing of one or more data marts associated with the user. As discussed above, the listing of data marts may include data marts that the user has created and/or data marts that the user has access. The data marts section 432 may list the name, service, description, author, modified data, validity, application, operations, and solution manager. Also included in the user interface 430 is a create data mart option 434 for creating a new data mart.

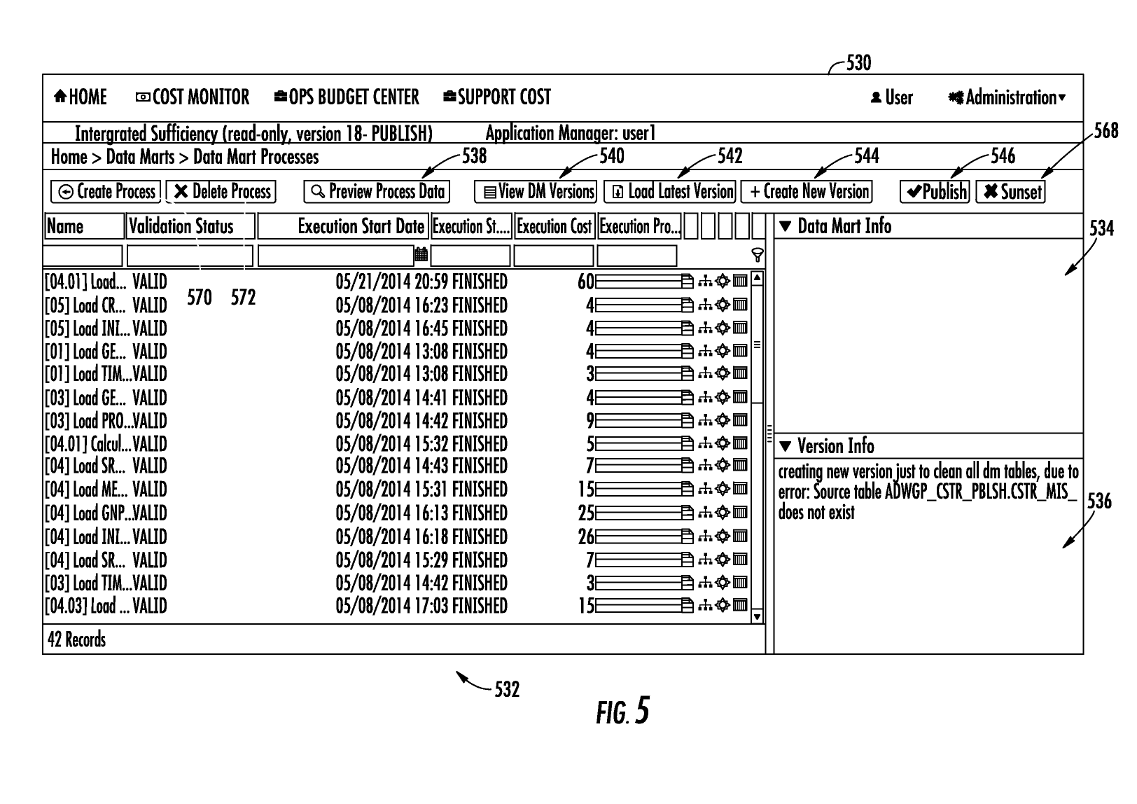

FIG. 5 depicts a user interface 530 for viewing data mart processes, according to embodiments disclosed herein. In response to selection of one of the data marts from the user interface 430 from FIG. 4 (or 330 from FIG. 3), the user interface 530 may be provided. Specifically, each data mart may have one or more processes associated therewith in order to provide the requested data from the data warehouse, which are provided in a process section 532.

Specifically, a data warehouse may include several types of data. In order to create a data mart, a process may be created to retrieve the desired information for that particular data mart, where the process may include a database source and an action. Depending on the particular data mart, there may be one or a plurality of different processes that are utilized to retrieve the desired data. Illustrated in FIG. 5 are 42 processes for a selected data mart. Also provided are a validation status of the process, an execution start date, an execution state, an execution cost, and an execution progress. The user interface 530 also includes a data mart information section 534, and a version information section 536. The data mart information section 534 may be configured to provide specific information regarding the selected data mart. This information may be similar to the information provided in the user interface 430 (FIG. 4) and/or may include information different than provided in FIG. 4. Similarly, as a data mart and/or process may include one or more versions, the version information section 536 may provide information related to a selected process and/or data mart and the versions associated therewith.

Also provided are a preview option 538, a view data mart version option 540, a load latest version option 542, a create new version option 544, a publish option 546, and a sunset option 568. A create process option 570 and a delete process option 572 are also provided. The preview option 538 may provide data that may be retrieved by the process. The view data mart version option 540 may provide version information regarding a specified data mart. The load latest version option 542 initiates an association of the latest version of the selected process into the data mart. A create new version option provides an additional interface for creating another version of a selected process. Based on the costs (described below), functionality, and/or other data, a user that utilizes a particular process may also be provided to select a desired version of that process. The publish option 546 publishes a newly created or edited process to the data mart. The sunset option 568 deletes an unpublished version of a process. The create process option 570 provides an option for the user to create a new process that is not necessarily a related version of an existing process. The delete process option 572 deletes a selected (and published) process from a data mart.

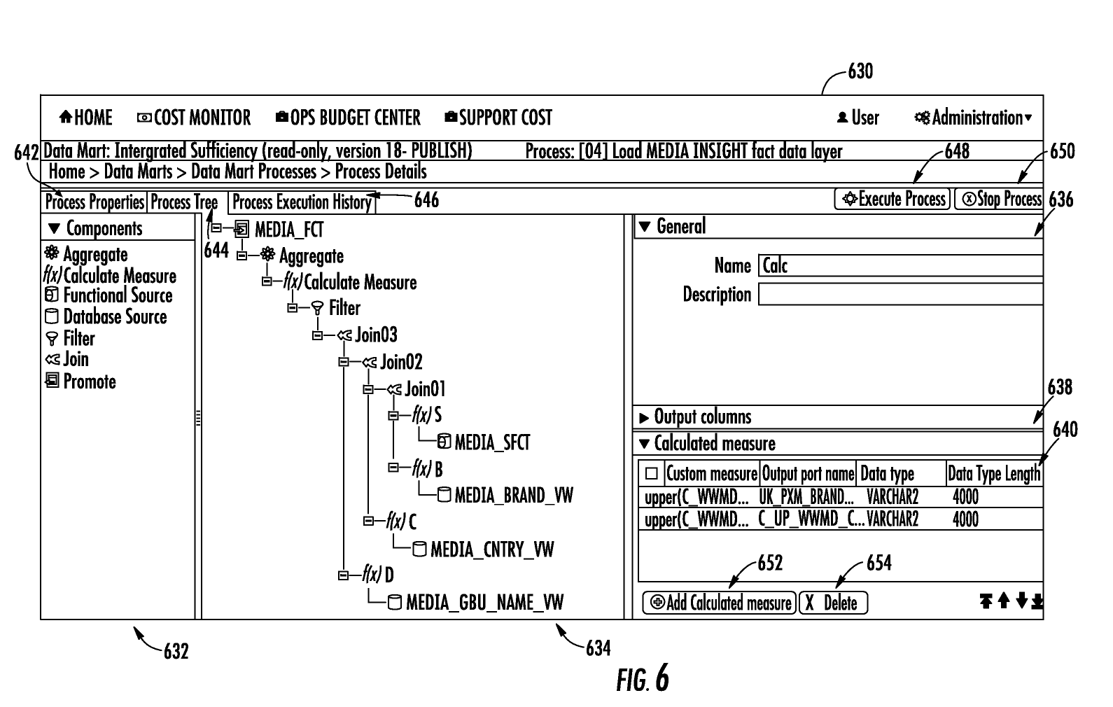

FIG. 6 depicts a user interface 630 for viewing process details for a data mart process, according to embodiments disclosed herein. In response to selection of the create process option 570 (FIG. 5), the user interface 630 may be provided. The user interface 630 provides a components section 632, a workspace section 634, a general section 636, an output columns section 683, and a calculated measure section 640. The components section 632 may include a toolbox of components that may be utilized to create a process. Specifically, an aggregate may be utilized to combine portions of the data warehouse for the process. Calculate measure may be utilized to execute a function. A functional source may be utilized to include a previously created process and/or data mart into the new process. A database source may be utilized to utilize a portion of an existing database. A filter may be utilized to reduce database entries that are provided by the process. A join component may be utilized to combine database sources and/or other components. A promote component may be utilized to add significance to a portion of the process and/or database.

Also included in the user interface 630 is the workspace section 634. The workspace section 634 provides a graphical depiction of a process. Specifically, a user may drag and drop components into the workspace section 634 for creating the process and/or data mart. Accordingly, the process may be easily created and/or edited by moving the component icons to and/or from the workspace section 634. Additionally, once the user publishes a data mart and/or process, that data mart and/or process may be provided as part of a repository for other users to utilize in creating new data marts and/or utilizing existing processes and data marts.

The general section 636 may be utilized for the user to enter a name, description and/or other general information regarding the newly created process. The output columns section 638 may be utilized for the user to enter the desired output columns of the process. The calculated measure section 640 may provide a custom measure, an output port name, a data type, a data length, and/or other information related to the process. An add calculated measure may also be included for the user to add an additional calculated measure. A delete option 654 may be provided to delete an existing calculated measure.

Also included are a process properties option 642, a process tree option 644, and a process execution history option 646. The process properties option 642 may be selected to provide properties regarding the process. The process tree option 644 may be selected to provide the process tree, as depicted in the workspace section 634. The process execution history option 646 may provide a listing or other depiction of a history of execution of the process. It will be understood that in response to the process properties option 642, the process tree option 644, and the process execution history option 646, the associated data may be provided in the workspace section 634. Also provided are an execute process option 648 and a stop process option 650 for executing and stopping execution of the process.

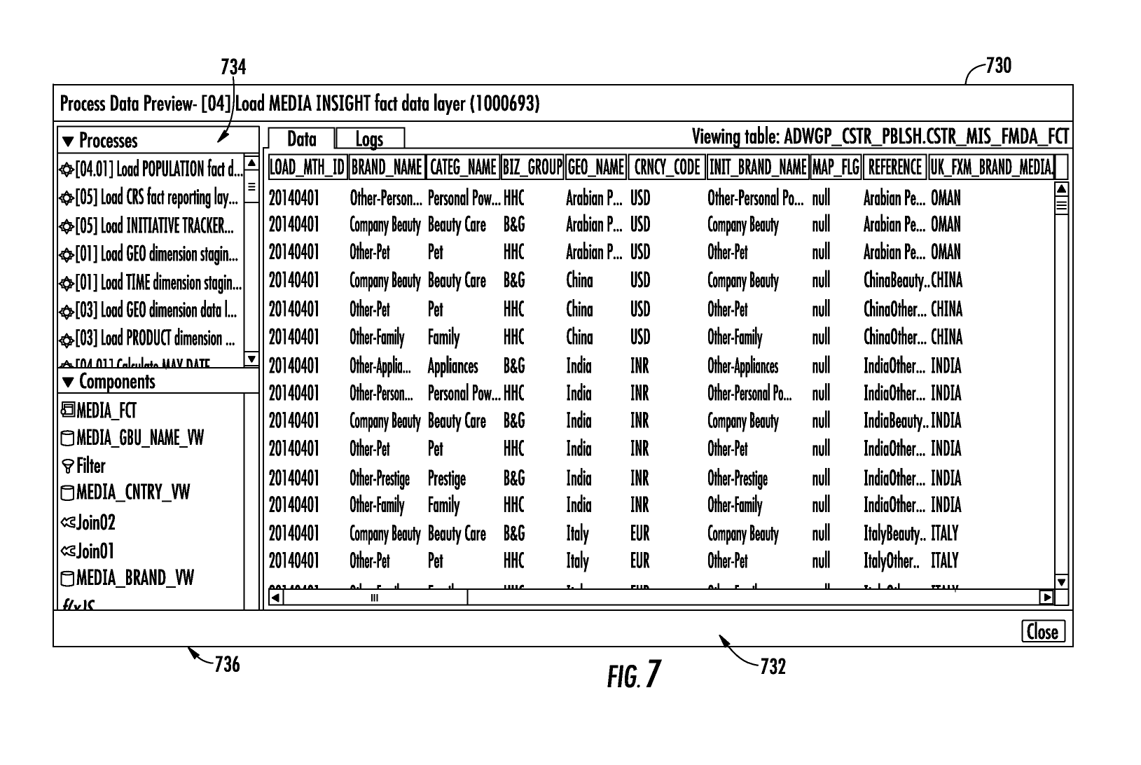

FIG. 7 depicts a user interface 730 for providing a process data overview, according to embodiments disclosed herein. In response to selection of the preview option 538 (FIG. 5), the user interface 730 may be provided. The user interface 730 includes a workspace section 732, a processes section 734, and a components section 736. The workspace section 732 may provide data associated with a process. Specifically, a load identifier may be provided, as well as a brand name, a category name, a business unit, a geography, a currency, an international brand name, a map flag, a reference, and a brand media. Also provided in the workspace section 732 is a logs section, which may provide log data associated with utilization of this data.

Additionally, the processes section 734 may provide processes that utilize the data depicted in the workspace section 732. Similarly, the components section 736 may provide components that are utilized with this data.

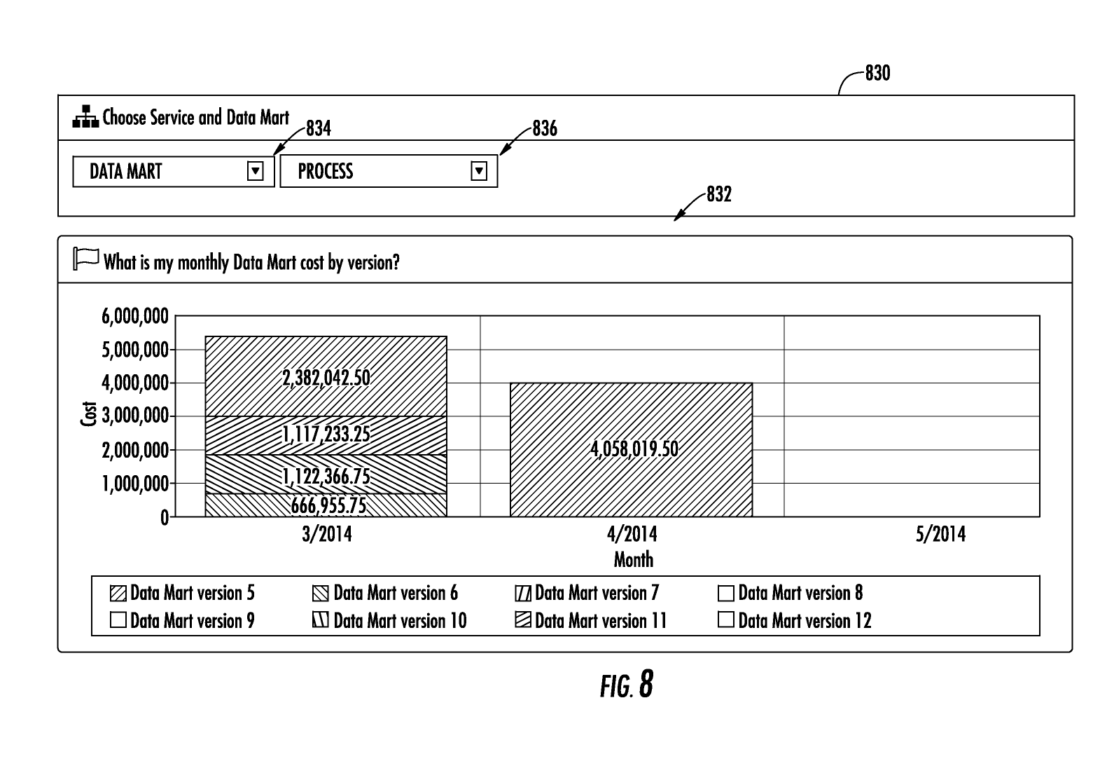

FIG. 8 depicts a user interface 830 for providing cost data associated with a data mart, according to embodiments disclosed herein. In response to selection of the cost monitor option 346 (FIG. 3), the user interface 830 may be provided. Specifically, the user interface 830 may include a data mart cost by version section 832. The data mart cost by version section 832 may include the cost over a predetermined time period for each version. This cost may be associated with a cost that is charged for utilizing a previously created process and/or data mart. Accordingly, the user interface 830 depicts that in March 2014, version 12, 11, 10, 9, and 6 are used, generating the depicted costs. In April of 2014, only version 12 was utilized, generating the depicted costs.

Specifically, executing a data mart may have associated costs with each execution (and/or costs over a predetermined amount of time). As the data mart may be updated, those updated versions may be more efficient and/or economical in that execution. Accordingly, the user interface 830 of FIG. 8 may be provided to identify these costs and provide the user with transparency regarding data mart costs. Also provided in the user interface 830 are options 834, 836 for identifying a data mart and/or process respectively to view the associated costs.

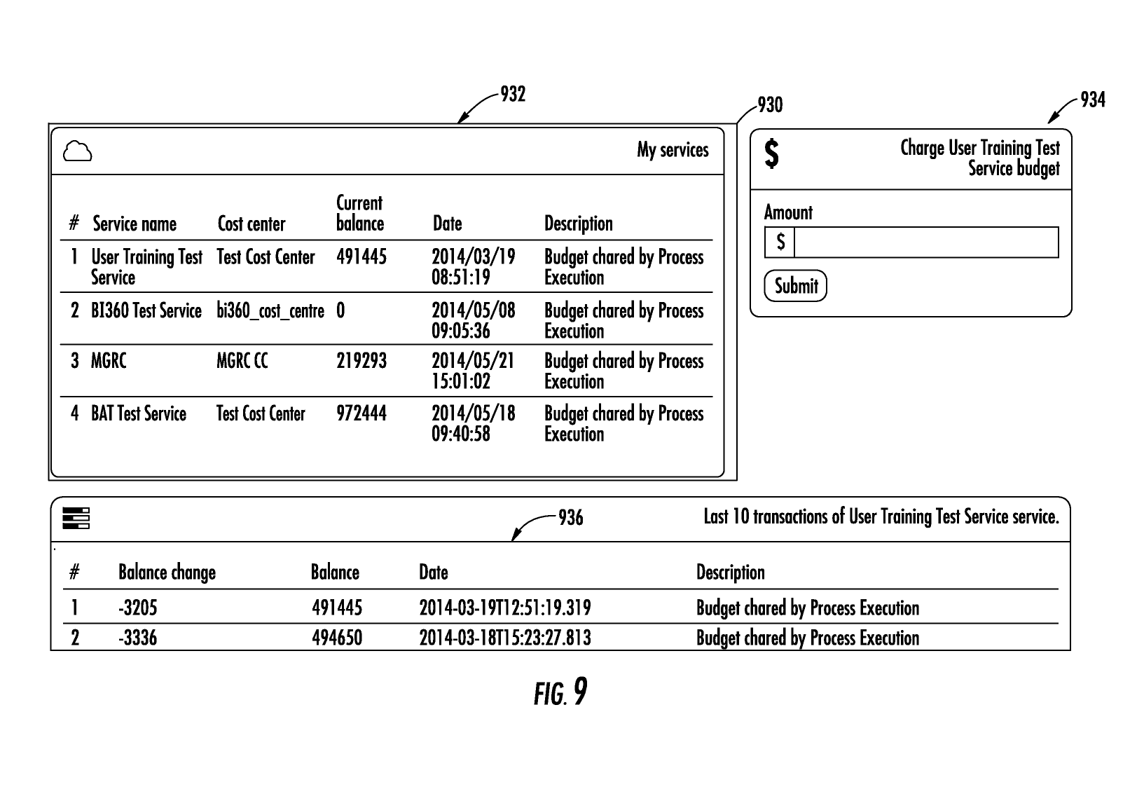

FIG. 9 depicts a user interface 930 for providing a data mart's cost and maintaining budget allocation, according to embodiments disclosed herein. In response to selection of a service from the personal services section 336 (FIG. 3), the user interface 930 may be provided. The user interface 930 includes a personal services section 932, a service budget section 934, and a transactions section 936. The personal services section 932 may provide a service name, cost center, current balance, date, and description of each of a plurality of service. The service budget section 934 provides a field for a user to identify an amount that training and/or service would cost for a particular service. Similarly, some embodiments may be configured to provide budget data, such as an actual support cost, a support cost budget, an actual cost correction, a cost correction budget, and/or a complexity value. The transactions section 936 depicts a balance change for a particular service. Specifically, the balance change, balance, date, and description of a particular transaction may be provided.

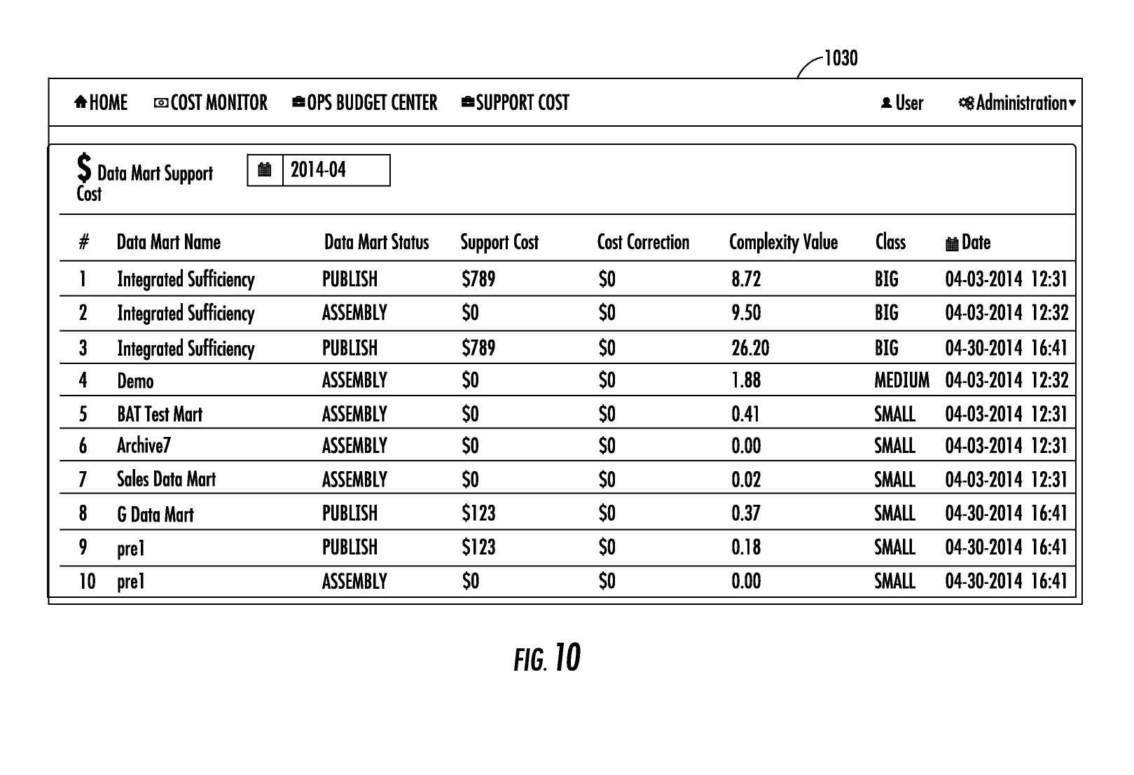

FIG. 10 depicts a user interface 1030 for providing data mart costs, according to embodiments disclosed herein. In response to selection of the support cost option 350 from FIG. 3, the user interface 1030 may be provided. Specifically, the user interface 1030 provides data mart support costs for a plurality of different data marts. The data mart name may be provided for an inventory of data marts, as well as the data mart status, the support cost, the cross correction, a complexity value, a class of data mart, and a date. The complexity value may be related to a complexity of a data mart as calculated via a predetermined algorithm This value may provide the user with context related to the complexity and thus the costs expected to be associated with a data mart.

Accordingly, the user interface 1030 provides the user with transparency regarding support costs and complexity of a predetermined data mart. This provides the ability to alter a data mart, based on need and/or identify whether to create a new data mart.

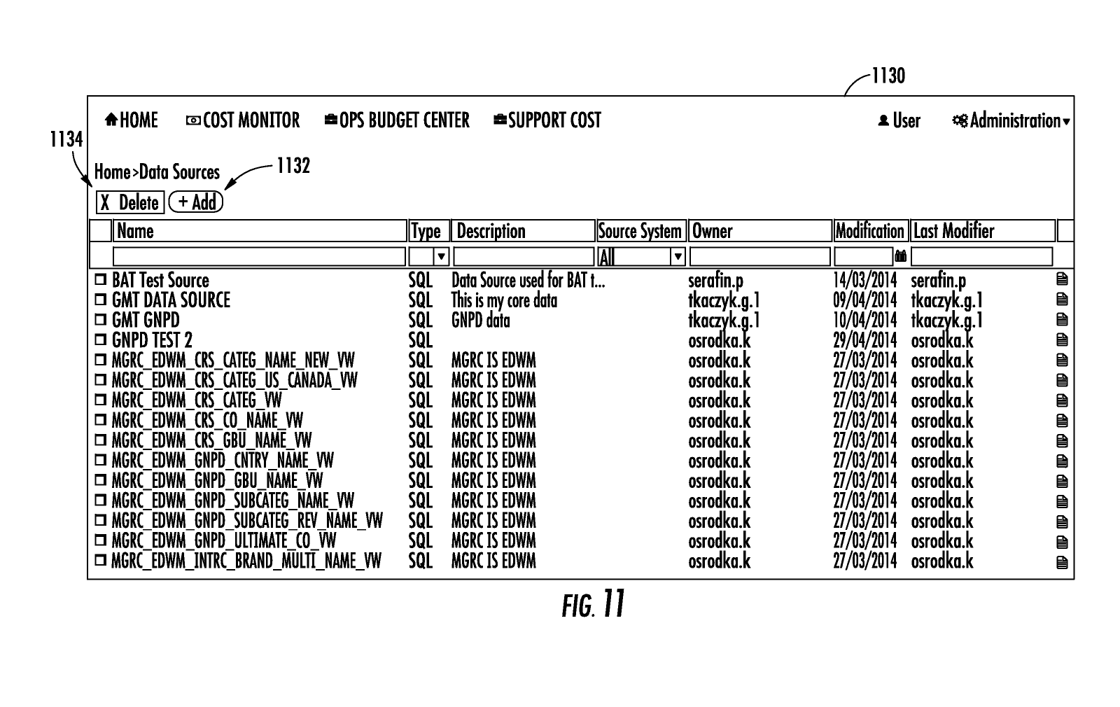

FIG. 11 depicts a user interface 1130 for adding, modifying, and/or deleting a data source, according to embodiments disclosed herein. As illustrated, the user may have a plurality of data sources and/or databases available for utilizing with a data mart. Specifically, depending on the particular data mart, user, and/or process, certain data sources may be desired. Accordingly, the user interface 1130 provides an add option 1132 and a delete option 1134 for adding and deleting data sources respectively.

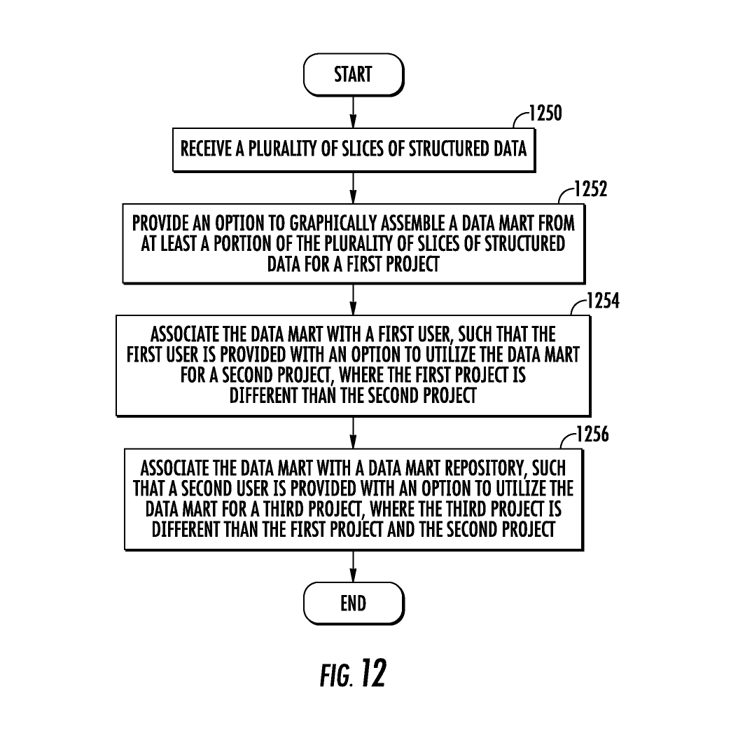

FIG. 12 depicts a flowchart for assembling data marts, according to embodiments disclosed herein. As illustrated in FIG. 1250, a plurality of slices of structured data may be received. In block 1252, an option to graphically assemble a data mart from at least a portion of the slices of structured data may be provided for a first project. In block 1254, the data mart may be associated with a first user, such that the first user is provided with an option to utilize the data mart for a second project, where the first project is different than the second project. In block 1256, the data mart may be associated with a data mart repository, such that as second user is provided with an option to utilize the data mart for a third project, where the third project is different than the first project and the second project.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm. ”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be understood to those skilled in the art that various other changes and modifications can be made without departing from the spirit and scope of the invention. It is therefore intended to cover in the appended claims all such changes and modifications that are within the scope of this invention.

What is claimed is:

1. A system for assembling data marts, comprising:
a memory component that stores logic that, when executed by a processor, causes the system to perform at least the following:
receive a plurality of slices of structured data;
provide an option to graphically assemble a data mart from at least a portion of the plurality of slices of structured data for a first project;
associate the data mart with a first user, such that the first user is provided with an option to utilize the data mart for a second project, wherein the first project is different than the second project; and
associate the data mart with a data mart repository, such that a second user is provided with an option to utilize the data mart for a third project, wherein the third project is different than the first project and the second project.

2. The system of claim 1, wherein the logic further causes the system to provide budget data associated with the data mart, wherein the budget data includes at least one of the following:
an actual support cost, a support cost budget, an actual cost correction, a cost correction budget, and a complexity value.

3. The system of claim 1, wherein the logic further causes the system to provide an inventory of the data mart and other data marts that the first user may access for the third project.

4. The system of claim 1, wherein assembling the data mart includes creation of a process, wherein the process includes a database source and an action.

5. The system of claim 1, wherein the data mart is first assembled without following a traditional application development life cycle with gated phases.

6. The system of claim 1, wherein the logic further causes the system to perform at least the following:
provide an option to create a second version of the data mart;
determine cost data for the data mart and a cost for the second version of the data mart; and
provide a user interface with the cost data to the first user.

7. The system of claim 1, wherein the logic further causes the system to provide an option to add a data source for assembling the data mart.

8. A method for data mart assembly, comprising:
receiving, by a computing device, a plurality of slices of structured data;
providing, by the computing device, an option to graphically assemble a data mart from at least a portion of the plurality of slices of structured data for a first project;
providing, by the computing device, an option to access a previously created data mart from a data mart repository for inclusion in the first project; and
associating, by the computing device, the data mart with a first user, such that the first user is provided with an option to utilize the data mart for a second project, wherein the first project is different than the second project.

9. The method of claim 8, further comprising associating the data mart with the data mart repository, such that a second user is provided with an option to utilize the data mart for a third project, wherein the third project is different than the first project and the second project.

10. The method of claim 8, providing budget data associated with the data mart, wherein the budget data includes at least one of the following: an actual support cost, a support cost budget, an actual cost correction, a cost correction budget, and a complexity value.

11. The method of claim 8, further comprising creating a process, wherein the process includes a database source and an action.

12. The method of claim 8, further comprising encapsulating multi-step processing business logic into the data mart.

13. The method of claim 8, further comprising:
providing an option to create a second version of the data mart;
determining cost data for the data mart and a cost for the second version of the data mart; and
providing a user interface with the cost data to the first user.

14. The method of claim 8, further comprising providing an option to add a data source for assembling the data mart.

15. A non-transitory computer-readable medium for data mart assembly that stores logic that causes a computing device to perform the following:
receive a plurality of slices of structured data;
provide an option to graphically assemble a data mart from at least a portion of the plurality of slices of structured data for a first project;
in response to receiving a user command to graphically assemble the data mart, create the data mart and assemble the data mart with a user-selected component;
provide an option to access a previously created data mart from a data mart repository for inclusion in the first project; and
associate the data mart with a first user, such that the first user is provided with an option to utilize the data mart for a second project, wherein the first project is different than the second project.

16. The non-transitory computer-readable medium of claim 15, wherein the logic further causes the computing device to provide budget data associated with the data mart, wherein the budget data includes at least one of the following: an actual support cost, a support cost budget, an actual cost correction, a cost correction budget, and a complexity value.

17. The non-transitory computer-readable medium of claim 15, wherein the logic further causes the computing device to provide an inventory of the data mart and other data marts that the first user may access for a third project.

18. The non-transitory computer-readable medium of claim 15, wherein the data mart has no interdependencies with any other data mart.

19. The non-transitory computer-readable medium of claim 15, wherein the logic further causes the computing device to perform at least the following:
provide an option to create a second version of the data mart;
determine cost data for the data mart and a cost for the second version of the data mart; and
provide a user interface with the cost data to the first user.

20. The non-transitory computer-readable medium of claim 15, wherein the logic further causes the computing device to provide an option to add a data source for assembling the data mart.
